(19) United States
(12) Patent Application Publication
(10) Pub. No.: US 2017/0147201 A1
(43) Pub. Date: May 25, 2017

(54) DOWNLOADABLE MOBILE KEYBOARD WITH ENHANCED FUNCTIONALITY

(71) Applicant: AnchorFree Inc., Menlo Park, CA (US)

(72) Inventor: David Gorodyansky, San Francisco, CA (US)

(21) Appl. No.: 14/948,393

(22) Filed: Nov. 23, 2015

(51) Int. Cl. G06F 3/0488; H04L 29/08; H04W 88/02

(52) U.S. Cl. CPC G06F 3/04886; H04W 88/02; H04L 67/02

(57) ABSTRACT

In accordance with one aspect of the embodiments described herein, there are provided systems and methods for implementing a mobile keyboard software application that can be downloaded to and installed on virtually any mobile device, including mobile devices executing under iOS, Android, Windows Mobile, Linux and the like. The aforesaid downloadable keyboard software application adds an enhanced cross-platform functionality to any user application executing on the user's mobile device. In one embodiment, the aforesaid downloadable keyboard software application is configured to add a functionality of a first software application executing on the mobile device into a second software application executing on the mobile device. In one or more embodiments, the keyboard may incorporate functionality of a convention keyboard in addition to special functions described in detail below.

### BACKGROUND OF THE INVENTION

### Technical Field

The disclosed embodiments relate in general to mobile devices and software therefor and, more specifically, to a downloadable mobile keyboard with a cross-platform functionality.

### Description of the Related Art

With the release of iOS 8, Apple has allowed installation of downloadable third party keyboards on its mobile devices, such as iPhone, iPad and iPod. A similar functionality has been available on Android devices for some time. This opens an avenue for providing new and improved functionality to existing mobile applications without having to rewrite their program code.

Therefore, new and improved downloadable keyboards are needed that would provide improved user experience by imparting new functionality to existing mobile applications.

### SUMMARY OF THE INVENTION

The embodiments described herein are directed to methods and systems that substantially obviate one or more of the above and other problems associated with conventional mobile keyboards.

In accordance with one aspect of the embodiments described herein, there is provided a computer-implemented method performed in a computerized system comprising a central processing unit, a display device and a memory, the computer-implemented method comprising: using the central processing unit to execute a plurality of user applications; using the display device to generate a graphical user interface, the graphical user interface comprising a keyboard portion for receiving a content or designation of the content from a user; receiving, using the keyboard portion, the content or designation of the content from a user; and substantially simultaneously providing the received or designated content to the plurality of user applications.

In one or more embodiments, the content is a textual message.

In one or more embodiments, the content is a graphical content.

In one or more embodiments, the content is a video content.

In one or more embodiments, the plurality of user applications are client applications for a plurality of social networks and wherein the content is posted to the plurality of social networks.

In one or more embodiments, the content is provided to the plurality of social networks via an HTTP or HTTPS protocols.

In one or more embodiments, the received content is provided to the plurality of user applications by creating and sending a content link pointing to the content and wherein the content link is configured to become inactive when a predetermined condition is satisfied.

In one or more embodiments, the graphical user interface comprises a link condition portion for specifying a condition for inactivation of the content link.

In one or more embodiments, the condition for inactivation of the content link comprises is a lapsed time condition, wherein the link becomes inactive upon passing of the lapsed time.

In one or more embodiments, the condition for inactivation of the content link comprises is a number of views condition, wherein the link becomes inactive upon a predetermined number of views.

In one or more embodiments, the condition for inactivation of the content link comprises is a number of clicks condition wherein the link becomes inactive upon a predetermined number of clicks.

In one or more embodiments, the content is downloaded from a second user application executed by the central processing unit, the second user application being separate and distinct from the plurality of user applications.

In one or more embodiments, the content pointed to by the content link is stored on a remote server and wherein the content link is a URL of the stored content.

In one or more embodiments, the content is provided to the plurality of user applications in an encrypted form.

In one or more embodiments, the content is an operating system command.

In one or more embodiments, at least some of the plurality of user applications are client applications associated with social networks.

In one or more embodiments, the computerized system further comprises a camera and wherein the content is captured using the camera.

In one or more embodiments, the computerized system further comprises a content storage and wherein the content is designated from the content storage.

In accordance with another aspect of the embodiments described herein, there is provided a computer-implemented method performed in a computerized system comprising a central processing unit, a display device and a memory, the computer-implemented method comprising: using the display device to generate a graphical user interface, the graphical user interface comprising a keyboard portion for receiving a content or designation of the content from a user and a secure transmission widget; receiving, using the keyboard portion, the content or designation of the content from a user; automatically enabling a virtual private network service; upon detection of user's activation of the secure transmission widget, automatically providing the received or designated content to a remote service using a virtual private network connection provided by the enabled virtual private network service.

In accordance with yet another aspect of the embodiments described herein, there is provided a computer-implemented method performed in a computerized system comprising a central processing unit, a display device and a memory, the computer-implemented method comprising: using the display device to generate a graphical user interface, the graphical user interface comprising a keyboard portion and a secure payment widget; upon detection of user's activation of the secure payment widget, initiating a payment process and receiving from the user, via the keyboard portion, a payment information; and completing a secure payment based on the payment information received from the user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIGS. 1, 2, 3, 4, 5, 6 and 7 illustrates logical diagrams of various systems that may be used to implement the described exemplary embodiments of an inventive mobile keyboard application.

FIG. 8 illustrates an exemplary embodiment of a computer platform whereupon the various embodiments described herein may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one aspect of the embodiments described herein, there are provided systems and methods for implementing a mobile keyboard software application that can be downloaded to and installed on virtually any mobile device, including mobile devices executing under iOS, Android, Windows Mobile, Linux and the like. The aforesaid downloadable keyboard software application adds an enhanced cross-platform functionality to any user application executing on the user's mobile device. In one embodiment, the aforesaid downloadable keyboard software application is configured to add a functionality of a first software application executing on the mobile device into a second software application executing on the mobile device. In one or more embodiments, the keyboard may incorporate functionality of a convention keyboard in addition to special functions described in detail below.

Specific exemplary embodiments of the aforesaid downloadable keyboard software application will now be described in detail. In a first exemplary embodiment, the aforesaid downloadable keyboard software application is configured to generate a graphical user interface on the display of the user's mobile device. The aforesaid graphical user interface may incorporate conventional keyboard buttons arranged in accordance with conventional keyboard layout, or otherwise. The user may use these buttons to input text, take pictures or video, select existing files, etc. In one embodiment, the inventive keyboard application is configured to receive from the user, using the touchscreen display interface of the user's mobile device, a message typed by a user and cause this message to substantially simultaneously appear in any one or multiple software applications. In one exemplary embodiment, a textual message typed in connection with this embodiment of a downloadable keyboard software application may be transmitted to, and appear in multiple different messaging applications executing on the mobile device. For example, such a message may be transmitted by the inventive keyboard application to an email application, a short messaging service (SMS) application, a social networking application, such as Facebook or Twitter, a communication application such as Skype and the like. The receiving email application, a short messaging service (SMS) application, a social networking application, such as Facebook or Twitter, a communication application such as Skype and the like would, in turn, transmit the received message to its intended destination. In another exemplary embodiment, an existing or newly taken image, such as a selfie, or an existing or newly recorded video or any other type of content file, shared by the user using the aforesaid embodiment of the keyboard application may be substantially simultaneously posted to multiple social networks or other resources available on the Internet, such as online (cloud) storage systems, such as Dropbox. To this end, the inventive keyboard application may generate a user interface incorporating a special button, such as a “share” or “share to all” button or other similar graphical user interface widget, for activating device's built-in camera from the aforesaid keyboard, performing content capture using the activated camera and sharing the acquired pictures or video with multiple social networks or other resources available on the Internet.

The content may be shared with the social networks or content storage services directly using, for example, HTTP or HTTPS protocols well known to persons of ordinary skill in the art, or by transmitting the content to a client application for such social networks executing locally on the mobile device.

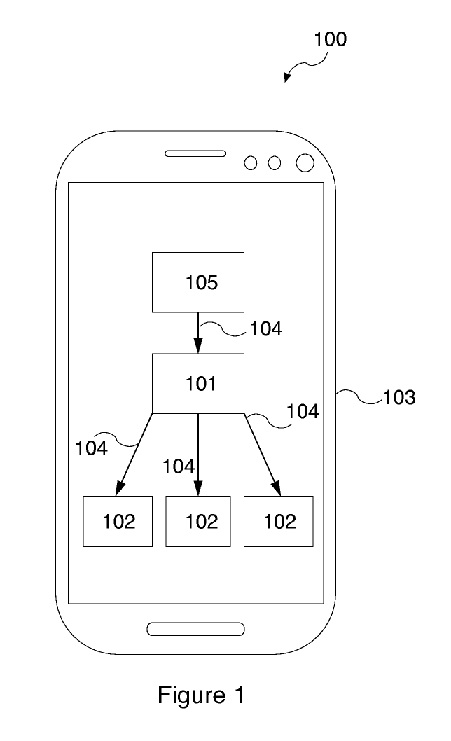

FIG. 1 illustrates a logical diagram of a system 100 that may be used to implement the above exemplary embodiments. The system incorporates the inventive mobile keyboard application 101 as well as multiple applications 102, such as messaging applications executing on a mobile device 103, such as a mobile (smart) phone. Upon the receiving of the input from the user by means of a touch screen interface 105, the mobile keyboard application 101 is configured to transmit the received input 104, including any text, graphics or video, or other content, to each of the multiple applications 102. On one or more embodiments, the multiple applications 102 may be remotely hosted or distributed applications, such as web services accessible over the Internet or other data transmission network.

In a second exemplary embodiment, the inventive keyboard application is configured to provide the ability to the user to send pictures, video, messages or other content that self-destructs to any social network or messaging application. In yet another embodiment, the keyboard application causes all emails or other messages typed with the aforesaid keyboard to self-destruct, enabling users to create and share self-destructing links for Internet content such as URLs, files, including document and data files, images, collection of images (albums), videos, text messages, and emails. In one or more embodiments, the keyboard system generates short URLs for each of these content types. In one or more embodiments, these URLs expire after a self-destruct condition set by the owner is satisfied.

In one embodiment, users creating a picture, video or message using the aforesaid keyboard, are provided with a user interface to set a timer for the life of the picture, video or message. Similarly, the user may specify a number of content views, clicks on the content link, or other condition after which the content destructs. In various embodiments, the expiration/access timer for the aforesaid URLs, files, including document and data files, images, collection of images (albums), videos, text messages, emails or other content could be set by the user such that the content could be viewed after passing of a predetermined amount of time. For example, a first user sends a second user a message and the second user receives it, but can only view it after 3 days from the date of the receipt. As would be appreciated by persons of ordinary skill in the art, the invention is not limited to any specific condition for expiration of the content link and any such condition may be used in connection with the described system.

After the timer information or other condition is input by the user, the aforesaid picture, video or message is configured to self-destruct on any social network or messaging application within the specified timer information. The same technique may be used in connection with email messages or any other form of communication. In one embodiment, the user types a message, email or takes or selects a picture or video using the inventive keyboard and also chooses one or multiple mobile applications with which this message or other content will be shared. If the user also specified the time for the content to self-destruct, then after the set amount of time or number of views, the content is replaced with a link to a server pointing to the content stored therein. This link may be shared with all applications specified by the user. At the specified time, the content link expires (e.g. the target content location becomes unavailable) and other users are no longer able to access the stored content.

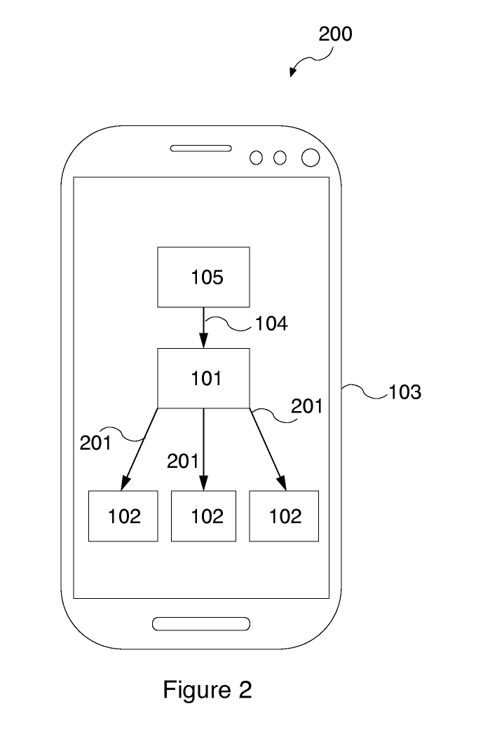

FIG. 2 illustrates an exemplary embodiment of a system 200 for implementing self-destructing messages or other content using the inventive keyboard. The system is similar to the system shown in FIG. 1, however, the inventive keyboard transmits not the content 104 itself, but a self-destructing link 201 to the content stored elsewhere to the multiple local or remote applications 102. Once the set time expires, the sent link becomes inactive and the other users are no longer able to view the content pointed to by the link. In one embodiment, the target content is removed from the specific location on the server, encrypted or access permissions to the content change so that the content is no longer accessible by recipients of the link. Exemplary implementations of the aforesaid self-destructing content links are described in detail in U.S. patent application Ser. No. 14/556,091, the disclosure of which is incorporated herein by reference in its entirety.

In a third exemplary embodiment, the inventive mobile keyboard application is configured to act like a cross application layer that can “upload” or “download” content from one mobile application and share such content with another mobile application executing on the mobile device. In one exemplary embodiment, the inventive keyboard application is configured to download a picture, a video or other content from one messaging application and seamlessly share this content with another application. To this end, the inventive keyboard application may generate a graphical user interface incorporating an “upload” and “download” buttons or other control widgets. A user clicking on the aforesaid “upload” widget in connection with a picture or message created by the keyboard, may cause the aforesaid content to be uploaded to any social network and have it expire after a set amount of time, views, or clicks. A user clicking the “download” widget will cause the inventive mobile keyboard application to automatically download a picture or other content from one social network or application and upload it into another.

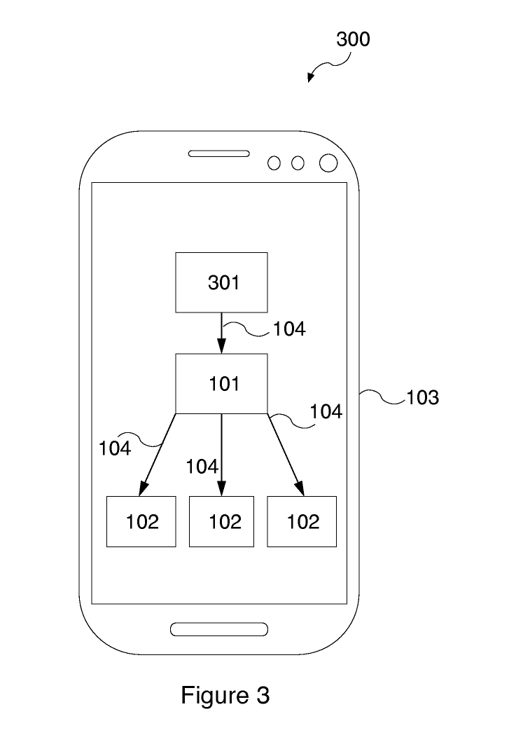

FIG. 3 illustrates an exemplary embodiment of a system 300 for implementing the aforesaid “upload” and “download” functionality using the inventive mobile keyboard application. The keyboard application 101 executing on the mobile device 103 “downloads” content 104 from one application 301 and “uploads” this content 104 to other mobile application 102.

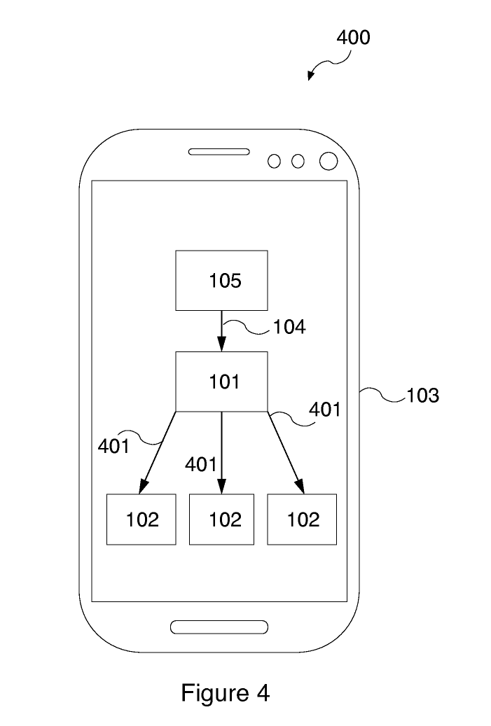

In a fourth exemplary embodiment, the aforesaid keyboard application incorporates an “encrypt” button. Any content created or selected by the user using the graphical user interface generated by the inventive keyboard application and provided (uploaded) to any local or remote applications, including, without limitations, cloud services, such as file storage or sharing services including Dropbox, may be automatically encrypted for security purposes using any now known or later developed encryption method(s). FIG. 4 illustrates an exemplary embodiment of a system 400 for implementing encryption of the content using the inventive keyboard application. The system is similar to the system shown in FIG. 1, however, the inventive keyboard transmits not the content 104 itself, but an encrypted content 401 to the multiple local or remote applications 102. In various embodiments, the remote applications 102 may include online (cloud) file storage applications, such as Dropbox, social networking applications, messaging platforms and the like. The content 104 may include image content, audio content, video content or any other types of content files or messages.

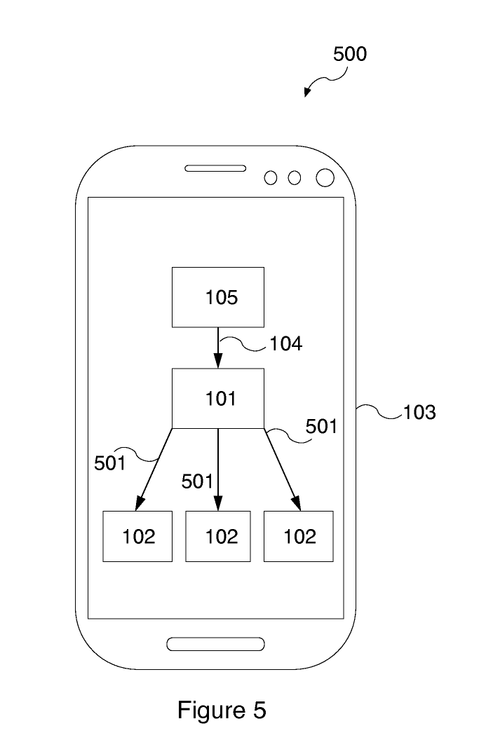

In a fifth exemplary embodiment, a graphical user interface generated by the inventive keyboard application incorporates a “VPN” button. Clicking this VPN button enables a virtual private network (VPN) client service on the user's device and causes all data transmissions from and to the user's mobile device 103 to be sent via a secure VPN tunnel 501, see FIG. 5. The inventive keyboard may interoperate with any existing or future VPN services, the method of operation of which is well known in the art. FIG. 5 illustrates an exemplary embodiment of such a system 500 for implementing VPN transmission of the content using the inventive keyboard application. The system is similar to the system shown in FIG. 1, however, the inventive keyboard transmits the content 104 via the encrypted VPN tunnel 501 to the multiple local or remote applications 102.

In a sixth exemplary embodiment, the inventive keyboard application is configured to generate a graphical user interface incorporating a “secure payment button.” Upon clicking this button, the inventive keyboard application is configured to initiate a monetary payment process for enabling users to send monetary payments thought their payment method of choice, such as PayPal, Apple Pay, Google Wallet, etc., right from the keyboard's graphical user interface, in a cross-platform manner.

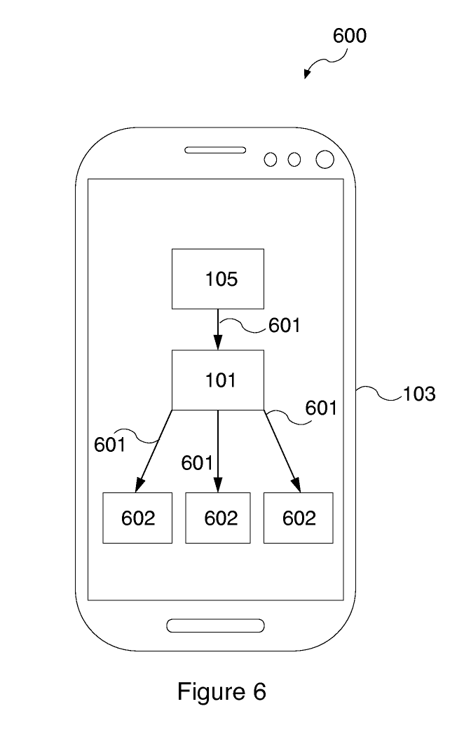

In one example, the users are enables to use the inventive keyboard application to send payment within different applications. In one embodiment, the keyboard application generates a graphical user interface with appropriate input fields and/or other primitives, for the user to enter their credit card or other payment method information and to complete payments for any goods or services or to send money to friends and family using the user's mobile device. In one embodiment, the keyboard connects to a payment application program interface (API) of the payment service of user's choice and enables the users to pay within any mobile app, without having to re-enter their credit card or other payment information. FIG. 6 illustrates an exemplary embodiment of such a system 600 for implementing mobile payments using the inventive keyboard application. The system is similar to the system shown in FIG. 1, however, the inventive keyboard transmits not the content 104 but secure payment information 601 to one or more secure payment services 602.

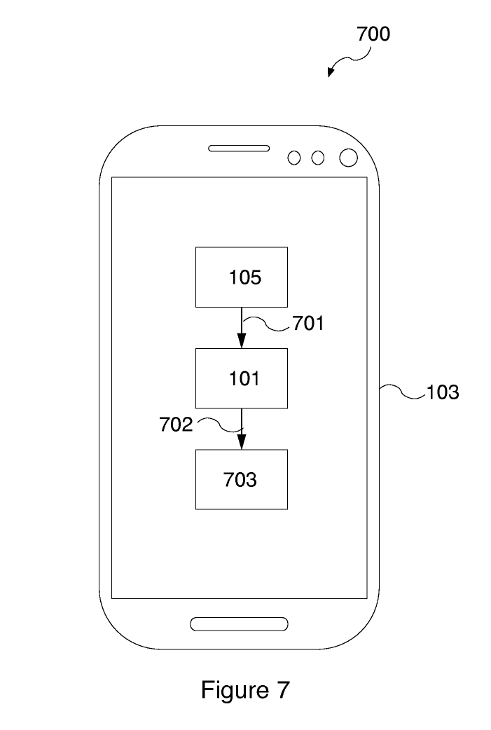

In a seventh exemplary embodiment, the keyboard acts as a mobile control center to control the operating system of the mobile device. In various embodiments, the graphical user interface generated by the inventive keyboard application may be used to issue commands to start and stop specific applications or processes, enable cross platform communication, enable sharing of the content within multiple applications, enable device and network security, and perform the like operating system control functions. FIG. 7 illustrates an exemplary embodiment of such a system 700 for implementing cooperating system function control using the inventive keyboard application. The keyboard application 101 receives commands 701 from the user using its graphical user interface and generates appropriate control commands 702 for the operating system 703 of the mobile device 103.

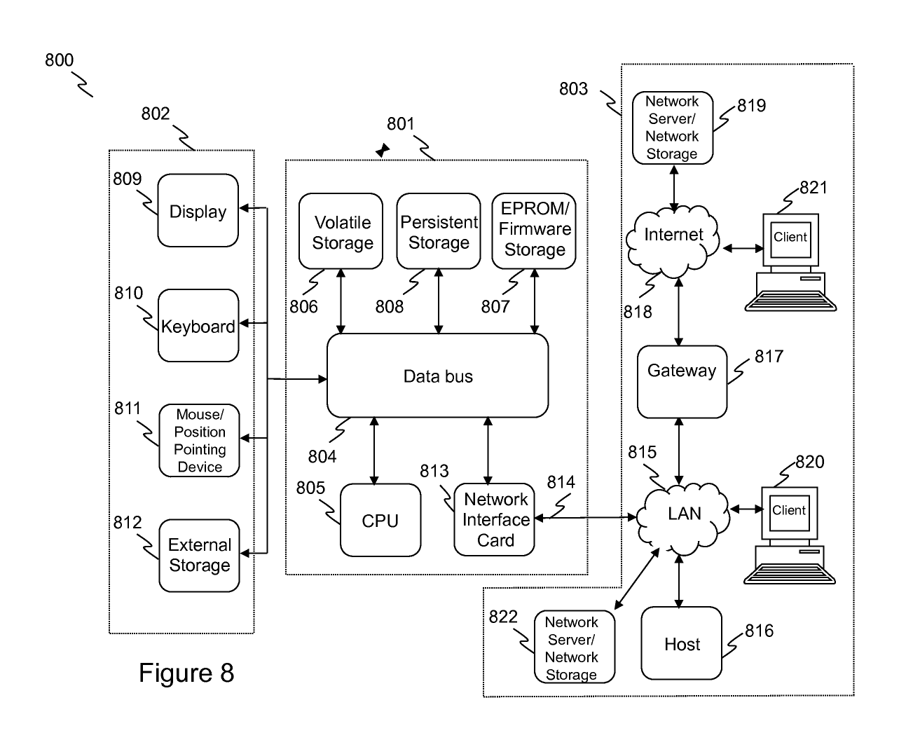

FIG. 8 is a block diagram that illustrates an embodiment of a computer system 800 upon which various embodiments of the inventive concepts described herein may be implemented. The system 800 includes a computer platform 801, peripheral devices 802 and network resources 803.

The computer platform 801 may include a data bus 804 or other communication mechanism for communicating information across and among various parts of the computer platform 801, and a processor 805 coupled with bus 804 for processing information and performing other computational and control tasks. Computer platform 801 also includes a volatile storage 806, such as a random access memory (RAM) or other dynamic storage device, coupled to bus 804 for storing various information as well as instructions to be executed by processor 805, including the software application for proxy detection described above. The volatile storage 806 also may be used for storing temporary variables or other intermediate information during execution of instructions by processor 805. Computer platform 801 may further include a read only memory (ROM or EPROM) 807 or other static storage device coupled to bus 804 for storing static information and instructions for processor 805, such as basic input-output system (BIOS), as well as various system configuration parameters. A persistent storage device 808, such as a magnetic disk, optical disk, or solid-state flash memory device is provided and coupled to bus 804 for storing information and instructions.

Computer platform 801 may be coupled via bus 804 to a touch-sensitive display 809, such as a cathode ray tube (CRT), plasma display, or a liquid crystal display (LCD), for displaying information to a system administrator or user of the computer platform 801. An input device 810, including alphanumeric and other keys, is coupled to bus 804 for communicating information and command selections to processor 805. Another type of user input device is cursor control device 811, such as a mouse, a trackball, or cursor direction keys for communicating direction information and command selections to processor 805 and for controlling cursor movement on touch-sensitive display 809. This input device typically has two degrees of freedom in two axes, a first axis (e.g., x) and a second axis (e.g., y), that allows the device to specify positions in a plane. To detect user's gestures, the display 809 may incorporate a touchscreen interface configured to detect user's tactile events and send information on the detected events to the processor 805 via the bus 804.

An external storage device 812 may be coupled to the computer platform 801 via bus 804 to provide an extra or removable storage capacity for the computer platform 801. In an embodiment of the computer system 800, the external removable storage device 812 may be used to facilitate exchange of data with other computer systems.

The invention is related to the use of computer system 800 for implementing the techniques described herein. In an embodiment, the inventive system may reside on a machine such as computer platform 801. According to one embodiment of the invention, the techniques described herein are performed by computer system 800 in response to processor 805 executing one or more sequences of one or more instructions contained in the volatile memory 806. Such instructions may be read into volatile memory 806 from another computer-readable medium, such as persistent storage device 808. Execution of the sequences of instructions contained in the volatile memory 806 causes processor 805 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 805 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 808. Volatile media includes dynamic memory, such as volatile storage 806.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 805 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 804. The bus 804 carries the data to the volatile storage 806, from which processor 805 retrieves and executes the instructions. The instructions received by the volatile memory 806 may optionally be stored on persistent storage device 808 either before or after execution by processor 805. The instructions may also be downloaded into the computer platform 801 via Internet using a variety of network data communication protocols well known in the art.

The computer platform 801 also includes a communication interface, such as network interface card 813 coupled to the data bus 804. Communication interface 813 provides a two-way data communication coupling to a network link 814 that is coupled to a local network 815. For example, communication interface 813 may be an integrated services digital network (ISDN) card or a modem to provide a data communication connection to a corresponding type of telephone line. As another example, communication interface 813 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 813 sends and receives electrical, electromagnetic or optical signals that carry digital data streams representing various types of information.

Network link 814 typically provides data communication through one or more networks to other network resources. For example, network link 814 may provide a connection through local network 815 to a host computer 816, or a network storage/server 822. Additionally or alternatively, the network link 814 may connect through gateway/firewall 817 to the wide-area or global network 818, such as an Internet. Thus, the computer platform 801 can access network resources located anywhere on the Internet 818, such as a remote network storage/server 819. On the other hand, the computer platform 801 may also be accessed by clients located anywhere on the local area network 815 and/or the Internet 818. The network clients 820 and 821 may themselves be implemented based on the computer platform similar to the platform 801.

Local network 815 and the Internet 818 both use electrical, electromagnetic or optical signals that carry digital data streams. The signals through the various networks and the signals on network link 814 and through communication interface 813, which carry the digital data to and from computer platform 801, are exemplary forms of carrier waves transporting the information.

Computer platform 801 can send messages and receive data, including program code, through the variety of network(s) including Internet 818 and LAN 815, network link 815 and communication interface 813. In the Internet example, when the system 801 acts as a network server, it might transmit a requested code or data for an application program running on client(s) 820 and/or 821 through the Internet 818, gateway/firewall 817, local area network 815 and communication interface 813. Similarly, it may receive code from other network resources.

The received code may be executed by processor 805 as it is received, and/or stored in persistent or volatile storage devices 808 and 806, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the downloadable mobile keyboard with a cross-platform functionality. It is intended that the specification and examples be considered as exemplary only, with a true scope and spirit of the invention being indicated by the following claims.

What is claimed is:

1. A computer-implemented method performed in a computerized system comprising a central processing unit, a display device and a memory, the computer-implemented method comprising:
a. using the central processing unit to execute a plurality of user applications;
b. using the display device to generate a graphical user interface, the graphical user interface comprising a keyboard portion for receiving a content or designation of the content from a user;
c. receiving, using the keyboard portion, the content or designation of the content from a user; and
d. substantially simultaneously providing the received or designated content to the plurality of user applications.

2. The computer-implemented method of claim 1, wherein the content is a textual message.

3. The computer-implemented method of claim 1, wherein the content is a graphical content.

4. The computer-implemented method of claim 1, wherein the content is a video content.

5. The computer-implemented method of claim 1, wherein the plurality of user applications are client applications for a plurality of social networks and wherein the content is posted to the plurality of social networks.

6. The computer-implemented method of claim 5, wherein the content is provided to the plurality of social networks via an HTTP or HTTPS protocols.

7. The computer-implemented method of claim 1, wherein the received content is provided to the plurality of user applications by creating and sending a content link pointing to the content and wherein the content link is configured to become inactive when a predetermined condition is satisfied.

8. The computer-implemented method of claim 7, wherein the graphical user interface comprises a link condition portion for specifying a condition for inactivation of the content link.

9. The computer-implemented method of claim 8, wherein the condition for inactivation of the content link comprises is a lapsed time condition, wherein the link becomes inactive upon passing of the lapsed time.

10. The computer-implemented method of claim 8, wherein the condition for inactivation of the content link comprises is a number of views condition, wherein the link becomes inactive upon a predetermined number of views.

11. The computer-implemented method of claim 8, wherein the condition for inactivation of the content link comprises is a number of clicks condition wherein the link becomes inactive upon a predetermined number of clicks.

12. The computer-implemented method of claim 8, wherein the content is downloaded from a second user application executed by the central processing unit, the second user application being separate and distinct from the plurality of user applications.

13. The computer-implemented method of claim 7, wherein the content pointed to by the content link is stored on a remote server and wherein the content link is a URL of the stored content.

14. The computer-implemented method of claim 1, wherein the content is provided to the plurality of user applications in an encrypted form.

15. The computer-implemented method of claim 1, wherein the content is an operating system command.

16. The computer-implemented method of claim 1, wherein at least some of the plurality of user applications are client applications associated with social networks.

17. The computer-implemented method of claim 1, wherein computerized system further comprises a camera and wherein the content is captured using the camera.

18. The computer-implemented method of claim 1, wherein computerized system further comprises a content storage and wherein the content is designated from the content storage.

19. A computer-implemented method performed in a computerized system comprising a central processing unit, a display device and a memory, the computer-implemented method comprising:
a. using the display device to generate a graphical user interface, the graphical user interface comprising a keyboard portion for receiving a content or designation of the content from a user and a secure transmission widget;
b. receiving, using the keyboard portion, the content or designation of the content from a user;
c. automatically enabling a virtual private network service; and
d. upon detection of user's activation of the secure transmission widget, automatically providing the received or designated content to a remote service using a virtual private network connection provided by the enabled virtual private network service.

20. A computer-implemented method performed in a computerized system comprising a central processing unit, a display device and a memory, the computer-implemented method comprising:
a. using the display device to generate a graphical user interface, the graphical user interface comprising a keyboard portion and a secure payment widget;
b. upon detection of user's activation of the secure payment widget, initiating a payment process and receiving from the user, via the keyboard portion, a payment information; and
c. completing a secure payment based on the payment information received from the user.
